(19) United States
(12) Patent Application Publication
(10) Pub. No.: US 2011/0090178 A1
(43) Pub. Date: Apr. 21, 2011

(54) Detecting method for pen-like optical input device with multiple optical components and optical input device thereof

(75) Inventors: Chien-Mo Lai, Taipei (TW); Tsu-Nan Lee, Taipei (TW); Sheau-Lin Li, Taipei (TW)

(73) Assignee: KYE SYSTEMS CORP., Taipei (TW)

(21) Appl. No.: 12/654,221

(22) Filed: Dec. 15, 2009

(30) Foreign Application Priority Data
Oct. 21, 2009 (TW) 098135676

(51) Int. Cl. G06F 3/033

(52) U.S. Cl. 345/179

(57) ABSTRACT

A detecting method for a pen-like optical input device with multiple optical components includes the following steps. At least two optical components for emitting light rays respectively are first enabled. The optical components are disposed within a pen-like body of the optical input device respectively at different angle. Next, the optical components separately emit light rays to a working surface respectively, so as to obtain at least two corresponding reflected light rays. Then, optical signals of the reflected light rays are detected and compared with each other to obtain a preferred optical result. Then, according to the optical result, a most appropriate optical component is selected to be enabled continuously for operation.

### CROSS-REFERENCE TO RELATED APPLICATIONS

This non-provisional application claims priority under 35 U.S.C. §119(a) on Patent Application No(s). 098135676 filed in Taiwan, R.O.C. on Oct. 21, 2009, the entire contents of which are hereby incorporated by reference.

### BACKGROUND OF THE INVENTION

1. Field of the Invention

The present invention relates to a peripheral input device, and more particularly to a detecting method for a pen-like optical input device with multiple optical components and an optical input device thereof.

2. Related Art

In recent years, with the rapid development and progress of technologies, computer equipment such as a personal computer (PC) or a notebook has become an indispensable convenient tool in people's daily life or work. However, the computer equipment must be installed with a pointer input device such as a mouse, a touchpad, or a trackball to perform manipulations on a window interface of the computer equipment.

Taking an optical mouse as an example, currently, a common optical mouse in a hemispherical domelike structure is only limited to being used in a conventional manner. Actually, due to a large shape and volume of the optical mouse, a user still cannot operate the optical mouse like holding a pen, thereby resulting in a dead angle to a certain extent in use. The conventional optical mouse in a hemispherical domelike structure also causes a lot of inconveniences in use due to the structure and shape designs. In order to solve the above problems, manufacturers have already started to provide an optical mouse with a pen-like structure in the market, which is convenient for the user to hold the mouse in operation, and conforms to the ergonomic habit of holding a penholder.

As disclosed in U.S. Pat. No. 6,151,015, in a pen-like optical mouse as a computer-aided input device, a light-emitting diode (LED) or a laser diode and an optical sensor are disposed inside a pen-like shell. The LED emits and projects light rays on a working surface. The optical sensor is then used to sense changes of light rays refracted back from the working surface and perform imaging, so as to generate a corresponding cursor movement signal and transmit the cursor movement signal to the computer equipment. When the pen-like optical mouse moves, its moving track is recorded as a group of consecutive pictures photographed at a high speed. Finally, an interface microprocessor inside the optical mouse is used to perform analysis and processing on the photographed pictures. Thus, a moving direction and a moving distance of the mouse are determined by analyzing changes of positions of feature points in the pictures, so as to position the cursor.

However, regardless of a hemispherical optical mouse or a pen-like optical mouse, due to the volume restriction, only a single optical sensor and a single LED can be disposed inside the mouse, and the LED can only emit light rays at a single wavelength, thereby causing various limitations on the use of the optical mouse. That is to say, the conventional optical mouse must be very close to a working surface, or even attached to the working surface, such that the requirement on the flatness of the working surface used together with the optical mouse is rather high, so as to ensure the cursor to be positioned successfully.

If the user makes the optical mouse generate up and down movements in the operation process to result in an excessively large distance away from the working surface, or the flatness of the working surface is rather poor, the optical signals represented by the reflected light rays generated after the LED emits the light rays onto the working surface are changed, such that confusion occurs when the optical sensor reads the optical signals, thereby causing a low contrast of the images sensed by the optical sensor, or even causing a situation that the cursor fails to be accurately positioned.

### SUMMARY OF THE INVENTION

In view of the above problems, the present invention is a detecting method for a pen-like optical input device with multiple optical components and an optical input device thereof, which are applicable to solve problems that a conventional optical mouse has to be attached to a working surface in use and causes various usage restrictions, and confusion occurs when an optical sensor reads optical signals due to the change of an angle between the optical mouse and the working surface, such that a cursor fails to be accurately positioned.

The present invention provides a detecting method for a pen-like optical input device with multiple optical components includes the following steps. The pen-like optical input device is disposed on a working surface. At least two optical components for emitting light rays respectively are first provided and enabled. The optical components are disposed within a pen-like body of the pen-like optical input device respectively at different angle. Next, the optical components separately emit light rays and project the light rays to the working surface respectively, so as to obtain at least two corresponding reflected light rays. Then, optical signals of the reflected light rays are detected and compared with each other to obtain a preferred optical result. Finally, a corresponding optical component is selected to be enabled continuously according to the optical result.

The optical input device in the present invention comprises a pen-like body, and at least two optical components and a light source sensing module disposed within the pen-like body. The at least two optical components disposed at one end of the pen-like body, and the optical components may separately emit light rays respectively, and continuously emit light rays to pass through the pen-like body onto a working surface, such that the working surface generates at least two reflected light rays. The light source sensing module is used for receiving the two reflected light rays.

When the pen-like body makes displacement relative to the working surface, the light source sensing module detects optical signals of the at least two reflected light rays and selects a corresponding optical component to be enabled continuously according to an angle between the pen-like body and the working surface. The light source sensing module receives the reflected light ray, so as to generate a control signal.

In the present invention, at least two optical components disposed at different inclining angles are provided, and the optical components emit light ray respectively. The light source sensing module detects optical signals generated by at least two light rays, so as to select a most appropriate optical component to be continuously enabled for operation. When the pen-like optical input device is operated at different angles relative to the working surface, different optical components may be switched in real time for actuation, so as to maintain an optimal sensing effect.

Therefore, the optical input device of the present invention can cater to the habitual holding gestures of different users and can be successfully used when different angles are formed between the optical input device and the working surface, such that the user is enabled to operate the optical input device easily without being restricted too much.

### BRIEF DESCRIPTION OF THE DRAWINGS

The present invention will become more fully understood from the detailed description given herein below for illustration only, and thus is not limitative of the present invention, and wherein:

FIG. 1 is a flow chart of steps according to an embodiment of the present invention;

FIG. 2 is a schematic view according to an embodiment of the present invention;

FIG. 3A is a schematic plan view according to an embodiment of the present invention; and

FIG. 3B is a schematic plan view according to an embodiment of the present invention.

### DETAILED DESCRIPTION OF THE INVENTION

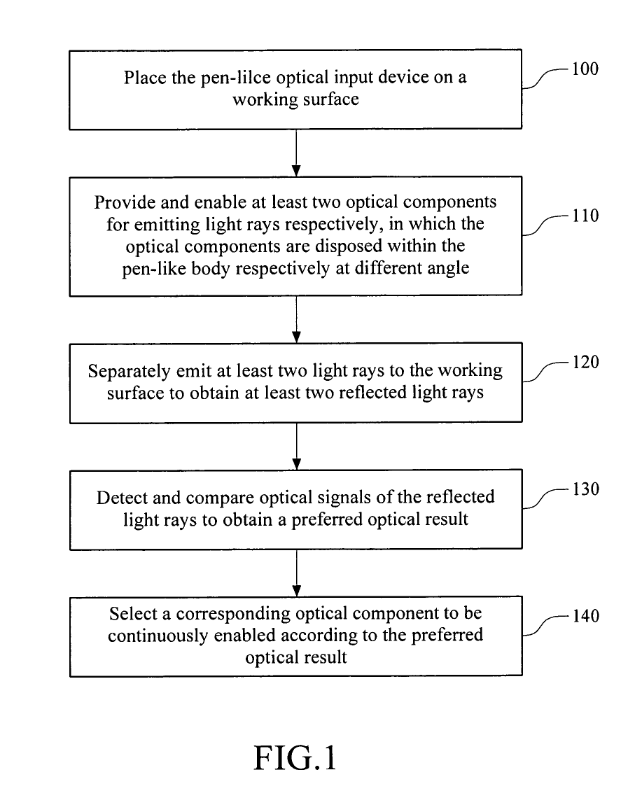

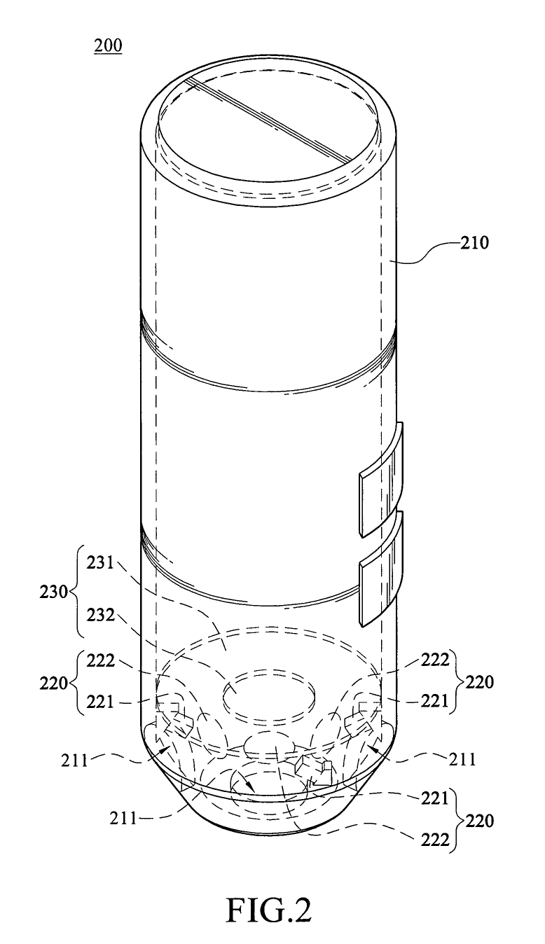

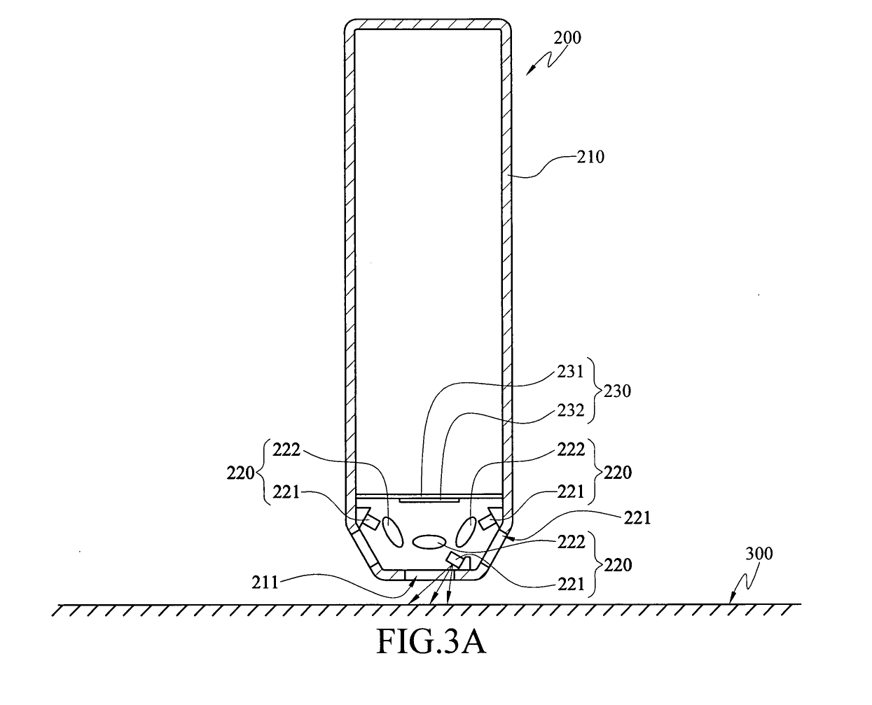

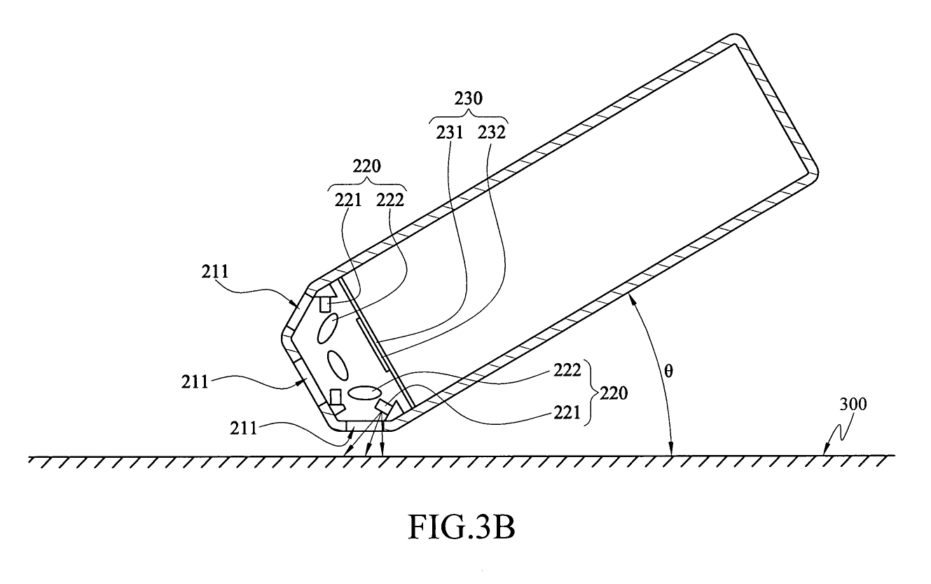

Referring to a flow chart shown in FIG. 1 and schematic views shown in FIGS. 2 and 3A, a pen-like optical input device 200 of the present invention comprises a pen-like body 210 and at least two optical components 220 and a light source sensing module 230 disposed within the pen-like body 210. The pen-like body 210 is a hollow cylindrical structure, similar to a penholder shape. At least two light holes 211 are opened in a bottom surface of the pen-like body 210. Each optical component 220 comprises a light source 221 and a lens 222, so as to from a single unit of components. The optical components 220 are respectively disposed within the pen-like body 210 respectively at different angle. The number of the light holes 211 is the same as that of the optical components 220, and each light hole 211 and each optical component 220 are disposed in a one-to-one relation. In addition, similar to the optical components 220, each light hole 211 is correspondingly opened in the bottom surface of the pen-like body 210 at different angle. The light source sensing module 230 comprises a circuit board 231 and an optical sensor 232. The optical sensor 232 is electrically disposed on the circuit board 231. The light source 221 of each optical component 220 emits a light ray towards each corresponding light hole 211 on the pen-like body 210 respectively. The optical sensor 232 and each lens 222 are disposed at positions corresponding to the light holes 211, and each lens 222 is located between the optical sensor 232 and each light hole 211.

Three light sources 221 disclosed in the present invention are disposed. Therefore, the number of the light holes 211 is also three. The light source 221 may be a light-emitting element such as an LED or laser diode, so as to emit light rays having directional characteristics. The optical sensor 232 may be a charged coupled device (CCD) or a complementary metal-oxide semiconductor (CMOS). However, the present invention is not limited to the disclosed embodiments.

In the detecting method for a pen-like optical input device with multiple optical components applicable to the pen-like optical input device 200 according to the present invention, the pen-like optical input device 200 is placed on a working surface 300 (Step 100), and at least two optical components 220 for emitting light rays respectively are provided and enabled, in which the optical components 220 are disposed within the pen-like body 210 respectively at different angle (Step 110). Next, the light sources 221 of the optical components 220 separately emit light rays and project the light rays to pass through the light holes 211 of the pen-like body 210 to a working surface 300 (for example, a desktop) respectively, such that the working surface 300 generates at least two corresponding reflected light rays respectively (Step 120). The so-called “emitted separately” means that the light rays are not projected to the same point, but form an intersecting configuration. The pen-like body 210 can be suspended on the working surface 300 as FIG. 3A, but not limited to that. The pen-like body 210 also can be attacked to the working surface 300.

The at least two reflected light rays enter the pen-like body 210 through the light holes 211 and are respectively refracted by the corresponding lenses 222 into the optical sensor 232 of the light source sensing module 230. The optical sensor 232 detects an optical signal represented by each reflected light ray, and performs dynamic comparison through a circuit system (not shown) of the pen-like optical input device 200, so as to obtain a preferred optical result (Step 130). Finally, according to the preferred optical result, a most appropriate optical component 220 is selected to be continuously enabled for operation (Step 140). The light source 221 of the present invention increases the light intensity through focusing by the lens 222. The lens 222 disclosed in the present invention may be a lens of various configurations such as a double-convex lens, a double-concave lens, or a concave-convex lens. However, persons skilled in the art may select a lens with most preferred optical characteristics according to the practical using demands.

Specifically, when the pen-like optical input device 200 is operated in a manner of being vertical to the working surface 300 (as shown in FIG. 3A), the optical sensor 232 of the light source sensing module 230 detects and compares optical signals represented by the reflected light rays generated by the working surface 300, so as to determine the optical component 220 that is most suitable for the angle between the pen-like body 210 of the pen-like optical input device 200 and the working surface 300 at this time (for example, a set of optical components 220 with an optimal detected contrast value), and then the light source 221 of the optical component 220 is continuously enabled and the light sources 221 of the other optical components 220 are disabled. It should be noted that, the light source sensing module 230 may be independently disposed corresponding to the number of the optical components 220, or merely one light source sensing module 230 is disposed in the manner as that mentioned in this embodiment, so as to save the cost.

When the pen-like optical input device 200 is changed to be operated at an angle θ relative to the working surface 300 (as shown in FIG. 3B), the optical signals detected by the optical sensor 232 are changed, so that the at least two optical components 220 are all enabled again. The optical sensor 232 compares optical signals corresponding to the reflected light rays of the light sources 221 once again, determines the optical component 220 that is most appropriate for the angle between the pen-like body 210 of the pen-like optical input device 200 and the working surface 300 at this time, and enables the light source 221 of the optical component 220 continuously, such that the optical sensor 232 obtains an optimal optical capturing effect, and the pen-like optical input device 200 is enabled to position the cursor accurately.

In the present invention, at least two optical components disposed at different inclining angles are provided, and the optical components emit at least two light rays. The light source sensing module detects optical signals generated by the at least two light rays, so as to select a most appropriate optical component to be continuously enabled for operation. When the pen-like optical input device is operated at different angles relative to the working surface, different optical components may be switched in real time for actuation, so as to maintain an optimal sensing effect.

Therefore, the pen-like optical input device of the present invention can cater to the habitual holding gestures of different users and can be successfully used when different angles are formed between the optical input device and the working surface, such that the user is enabled to operate the optical input device easily without being restricted too much. In addition, an appearance of the optical input device is designed into a pen type, so that the optical input device can be easily carried along, and the user is enabled to hold and use the optical input device comfortably, which completely conforms to the ergonomics.

What is claimed is:

1. A detecting method for a pen-like optical input device with multiple optical components, the method comprising:
placing the pen-like optical input device on a working surface;
providing and enabling at least two optical components, wherein the at least two optical components emit light rays respectively, and the optical components are disposed within the pen-like body respectively at different angle
separately emitting at least two light rays and projecting the at least two light rays to the working surface, so as to obtain at least two corresponding reflected light rays respectively;
detecting and comparing optical signals of the reflected light rays to obtain a preferred optical result; and
selecting a corresponding optical component to be continuously enabled according to the preferred optical result.

2. The detecting method for a pen-like optical input device with multiple optical components according to claim 1, wherein the optical signals of the reflected light rays are detected by at least one light source sensing module.

3. The detecting method for a pen-like optical input device with multiple optical components according to claim 2, wherein each of the optical components comprises a light source and a lens.

4. The detecting method for a pen-like optical input device with multiple optical components according to claim 1, wherein each of the optical components comprises a light source and a lens.

5. An optical input device, comprising:
a pen-like body;
one end of the pen-like body has at least two optical components, disposed within the pen-like body respectively at different angle, wherein the at least two optical components separately emit light rays respectively, and continuously emit light rays to pass through the pen-like body to a working surface, such that the working surface generates at least two reflected light rays; and
at least one light source sensing module, disposed within the pen-like body, for receiving the at least two reflected light rays;
wherein when the pen-like body makes displacement relative to the working surface, the light source sensing module detects optical signals of the at least two reflected light rays, and selects a corresponding optical component to be enabled continuously according to an angle between the pen-like body and the working surface, and the light source sensing module receives the reflected light ray to generate a control signal.

6. The optical input device according to claim 5, wherein each of the optical components comprises a light source and a lens, the light source emits light rays, and the lens is used for refracting the at least two reflected light rays to the light source sensing module.

7. The optical input device according to claim 6, wherein the light source sensing module comprises a circuit board and an optical sensor, and the optical sensor is electrically disposed on the circuit board and used for receiving the at least two reflected light rays.

8. The optical input device according to claim 5, wherein the light source sensing module comprises a circuit board and an optical sensor, and the optical sensor is electrically disposed on the circuit board and used for receiving the at least two reflected light rays.

9. The optical input device according to claim 5, wherein the pen-like body comprises at least two light holes, disposed corresponding to the at least two optical components respectively, and provided for the at least two light rays and the at least two reflected light rays to pass through the pen-like body.

10. A pen-like optical input device, comprising:
a pen-like body, one end of the pen-like body comprising at least two light holes disposed separately at different angle, at least two optical components disposed separately, and at least one light source sensing module;
wherein the two optical components separately emit light rays respectively, the light rays pass through the light holes to a working surface respectively, the working surface generates a reflected light ray respectively, and the light source sensing module detects and determines optical signals of the two reflected light rays.

11. The pen-like optical input device according to claim 10, wherein each of the at least two optical components comprises a light source and a lens respectively.
